(19) United States
(12) Patent Application Publication
(10) Pub. No.: US 2010/0281094 A1
(43) Pub. Date: Nov. 4, 2010

(54) System for Consolidating and Securing Access to All Out-of-Band Interfaces in Computer, Telecommunication, and Networking Equipment, Regardless of the Interface Type

(76) Inventors: Graham Holt, Pleasanton, CA (US); Ivan Passos, Fremont, CA (US)

Correspondence Address: DAVIDSON BERQUIST JACKSON & GOWDEY LLP, 4300 WILSON BLVD., 7TH FLOOR, ARLINGTON, VA, 22203, US

(21) Appl. No.: 12/640,675

(22) Filed: Dec. 17, 2009

Related U.S. Application Data
(63) Continuation of application No. 11/208,704, filed on Aug. 22, 2005.

(51) Int. Cl. G06F 15/173; G06F 15/16

(52) U.S. Cl. 709/201; 709/223; 709/246; 709/230

(57) ABSTRACT

A system for physically consolidating and securing access to all Out-of-Band interfaces in computer, telecommunication and networking equipment, regardless of the interface type, isolating the management ports from the data network. The system converts low-level management protocols into higher-level network protocols suitable for secure transport over the data network. The system may encrypt the common format management data. The system may also authenticate each User that attempts to access the management interfaces.

### FIELD OF THE INVENTION

This invention relates to the field of computer network management and specifically to methods for accessing and managing computer, networking, and telecommunication systems that may utilize Out-of-Band techniques and protocols for remote management.

### BACKGROUND OF THE INVENTION

Information Technology professionals commonly use tools to remotely access and control Managed Devices such as computer servers, networking equipment and telecommunication systems. These typical remote access tools permit the IT professional to manage and restore the operations of the network nodes remotely. Typically, these remote access tools are divided in two categories: In-Band (“IB”) Tools and Out-of-Band (“OoB”) Tools. An In-Band Tool communicates with the Managed Device relying on the same network interface utilized by the Managed Device for connection to the data network. An Out-of-Band Tool communicates with the Managed Device using a separate access media (such as a serial console port or the keyboard-video-mouse interface) that is used exclusively for management. Out-of-Band Tools permit the User to access the Managed Device even when the Managed Device loses network connectivity.

In IB Tools, the User remotely manages the Managed Device using well known network protocols, such as Remote Desktop Protocol (RDP), Secure Shell (SSH) and Simple Network Management Protocol (SNMP). IB Tools allow network administrators to view and interact with the Managed Device using a simple program (the “Viewer” or Remote Access Client) on another computer anywhere on the network (Intranet, Internet and/or Extranet). The two computers need not be of the same type, so for example one can use an IB Tool to view a Linux server from their Windows PC at home.

FIG. 1 shows how IB Tools work. An IB Tool comprises three different components including: a Remote Access Service 1 which resides in a Managed Device 2; a Remote Access Client 4, which resides in a Client Node; and a Data Network 6, which is used as a communication path between the Server and the Client applications. Due to this architecture, any IB Tool requires the proper functioning of all three components to work. If the Managed Device is not functioning properly the Remote Access Service software will not be able to work properly and thus the Client Software will not be able to access the Managed Device. Likewise, if there is a problem in the Data Network, the Remote Access Client will not be able to reach the Remote Access Service making the solution unusable. For these reasons IB Tools are normally used for routine maintenance where there is little or no risk of an error occurring in any of the three components. Many IB Tools for remote access and monitoring are offered today, both open source and proprietary, such as HP Open View, IBM Tivoli, BMC Performance Manager and CA Unicenter.

IB Tools, however, become ineffective whenever the Data Network path associated with the Managed Device fails or the Managed Device loses network connectivity. To overcome this limitation, tools were created to enable remote access to the OoB management ports of the Managed Device. These OoB Tools use interfaces such as serial, KVM, service processor and environmental ports to generate management data.

FIG. 2 shows how OoB tools work. An OoB solution comprises two components. The OoB Device 10, which interfaces with the OoB interface 12 of the Managed Device 2 and converts the data to a format suitable for transmission over the network; and the Remote Access Client, which resides in the Client node and communicates with the OoB Device. The User may access the OoB Device through the Data Network, as well as directly. Furthermore, as the OoB interface is lower level than its IB counterpart, it operates independently of the Managed Device's Operating System, which makes it more reliable and less likely to become unavailable. OoB Devices in use today include Console Servers, like the Cyclades AlterPath ACS and the Lantronix SecureLinx; KVM over IP switches, like the Cyclades AlterPath KVM/net and the Avocent DS Series; Intelligent Power Distribution Units (IPDUs), like the Cyclades AlterPath PM and the APC MasterSwitch; and BMCs (Baseboard Management Controllers), like HP iLO, Dell DRAC, IBM RSA, Sun ALOM and IPMI.

There is a multitude of OoB interface types available, depending on the Managed Device. Network Devices and UNIX or Linux-based servers usually have RS-232 or RS-485 serial ports as their OoB interface. Windows servers, due to the graphical nature of their user interfaces, have Keyboard, Video and Mouse (KVM) as their OoB interface. Serial and KVM interfaces can be accessed in conjunction with the Managed Device's power outlets by the means of IPDUs—to provide maximum level of OoB control. More recently, server vendors such as IBM, HP, Sun and Dell have included service processors in their systems, which use common Ethernet media as their OoB interfaces and can provide both console access and power control, amongst other features. While an industry consortium has developed an interface called Intelligent Platform Management Interface (IPMI) to be used in service processors, some vendors have created similar proprietary interfaces. For example, HP has its Integrated Lights-Out (iLO) interface, Dell provides its Dell Remote Access Console (DRAC) and Sun Microsystems has its Advanced Lights Out Module (ALOM) interface. At an IT location or section level, environmental sensors measure variables such as temperature, humidity and water leaks. These environmental sensors and interfaces are also a part of the OoB Infrastructure.

The OoB Devices in use today, however, provide connectivity to just some of the OoB interface types. Console servers like the Cyclades AlterPath ACS and the Lantronix SecureLinx can connect to Managed Devices only through serial interfaces, with the ability to integrate with IPDUs to provide serial and power coverage. The Avocent DS Series and the Epicenter CenterLine can connect to Managed Devices through serial and KVM interfaces (also with power integration capabilities), but not through Ethernet-based service processor interfaces. No OoB Device in the market today allows for coverage of all OoB interface types, nor do they provide an architecture that allows them to support future OoB interfaces as these are introduced to the market. The resulting conventional situation is a typical heterogeneous IT environment that utilizes a plurality of disparate OoB Devices for a complete OoB solution of new and legacy systems.

FIG. 3 depicts a typical IT environment 18. This approach exhibits several key limitations as follows:
Managed Devices with different types of OoB interfaces require different OoB Devices. As OoB Devices have a fixed number of OoB interfaces to which they can connect, there will be cases where the total number of interfaces could be covered by one single OoB Device, but because there are multiple types of interfaces to be covered, the User needs to buy multiple OoB Devices, even though many ports in these devices will remain disconnected. This represents an extra investment in OoB Infrastructure, which is unnecessary at that early stage of deployment.
When new OoB technologies become available and start to be deployed, a full overhaul on the OoB Infrastructure is required to support these new Managed Devices. This overhaul goes from cabling and physical installation to configuration of new devices.
During the transition period between the disconnection of legacy OoB interfaces and its subsequent replacement by new OoB interfaces, Users need to support both legacy and new interfaces simultaneously. As OoB Devices today do not support all interfaces, Users are forced to deploy new OoB Devices without removing the old ones, which creates more infrastructure management overhead.
Once the legacy OoB technology is replaced, the investment made in that technology is irretrievably lost, as there is no part of that deployment that can be reused in the new environment.

All of these limitations relate to the fact that the OoB interfaces that connect Managed Devices to the OoB infrastructure are significantly different from each other at the physical and protocol level. For example, serial ports are very different from KVM ports in that OoB serial ports normally follow the EIA RS-232 electrical specification, and its interface can take many form factors such as DB-9, DB-25 and RJ-45. KVM ports, on the other hand, interface with not one, but three components of the Managed Device: the keyboard, video and mouse ports. Each of these ports has different electrical characteristics, such as PS/2 or USB for the keyboard and mouse, and VGA and DVI for the video interface. As another example, service processor ports are completely different from KVM and serial ports, as its physical interface is based on Ethernet and it runs a subset of the TCP/IP stack as its communication protocol. Beyond the interface level, however, the OoB Infrastructure is pretty uniform, offering similar features and functionality regardless of the physical interface.

Thus, the ideal solution to the problem would be to abstract the OoB interfaces from the rest of the OoB Infrastructure, so that interfaces can be changed and/or replaced without affecting the underlying infrastructure. Thus, a universal Out-of-Band gateway is provided that overcomes the limitations with the typical systems set forth above and it is to this end that the present invention is directed.

### SUMMARY OF THE INVENTION

A Universal Out-of-Band Gateway in accordance with the invention comprises a method for physically consolidating and logically securing the OoB connections needed for access to Managed Devices, regardless of the type of OoB interface in each device. This solution will lower operational costs and reduce complexity of deployment and maintenance of OoB Infrastructures. The invention is a system that combines hardware and software designed specifically for this function. It provides the required OoB connectivity to a plurality of Managed Devices and, at the same time, eliminates the need for different devices to handle different OoB interfaces.

The system comprises a stable infrastructure portion and a changeable infrastructure portion that are combined together to form the universal gateway system. The changeable infrastructure further comprises a set of Connectors and the stable infrastructure further comprises a Main Unit. For each Managed Device, one Connector will connect to its OoB interface and convert it into a common standard physical media protocol. The common standard physical media may connect each of the set of connectors to the main unit. The network interface of the Connector is then used to establish a point-to-point connection to the Main Unit. The Main Unit has multiple local network interfaces for one or more Connectors, plus one or more external network interfaces to provide access from Users into the system. In a preferred embodiment, the common standard physical media may be an Ethernet network or a USB network.

In accordance with the invention, there may be multiple different types of Connectors, one type of Connector for each OoB interface type supported by the system. The Connectors can be hardware-based, in case there is a need to convert the native OoB physical interface to the common standard physical media interface in order to communicate with the Main Unit, or software-based, in case the OoB physical interface is already the common standard physical media interface and the conversion requirements are limited to management protocols. The types of Connectors may also include an environmental Connector that may measure the temperature or humidity of the location. In accordance with the invention, all of the different types of Connectors may interface with the common standard physical media and then communicate with the main unit so that the universal gateway system.

The hardware-based Connectors may be referred to as Hard Connectors, and the software-based Connectors may be known as Soft Connectors. The soft connectors may comprise a software module that may be resident and executed by the main unit (since the particular management protocol does not require any hardware element) while the hard connector may further comprise a piece of hardware (to convert the management protocol/interface into the common standard physical media interface) as well as a piece of software that is executed by the piece of hardware or by the main unit. Several examples of the Hard Connectors in accordance with the invention are a Serial Connector (to interface with RS-232) or a well known keyboard video mouse (KVM) Connectors (to interface with the well known KVM management protocol). Several examples of Soft Connectors are connectors that interface with service processors, including but not limited to an IPMI Connector, an iLO Connector and a DRAC Connector.

In accordance with the invention, multiple different types of hard and soft connector types are available for the system in order to cover the existing needs for OoB connectivity. As new OoB interfaces become available, the system need not change drastically, but just change the changeable infrastructure by adding new Connector types to cover the new interfaces. This makes the Universal Out-of-Band Gateway a very extensible solution.

The Universal Out-of-Band Gateway retrieves and processes the management information from a plurality of sources and then expose the consolidated information to a local or remote management gateway, agent or human operator through one or more network connections using a higher-end, secure protocol suitable for transport over the wide area network which may include but is not limited to the following protocols: Secure Shell (SSH), Secure Socket Layer (SSL), Extended Markup Language (XML), Secure HyperText Transfer Protocol (HTTPS), or Data Center Markup Language (DCML).

The Universal Out-of-Band Gateway allows a user to build an OoB system independently of the OoB interfaces in use today or in the future by associating an OoB interface type with a connector and defining each connector as a separate device from the Main Unit so that a particular connector can be chosen for each Managed Device of the particular system. The system allows the user to build a very stable and long-lasting OoB Infrastructure all the way up to the Connector, and change the Connectors and Managed Devices as it becomes necessary.

The Universal Out-of-Band Gateway in accordance with the invention addresses the key limitations of existing OoB solutions. For example, managed devices with different types of OoB interfaces can now be covered by a single OoB Device which removes the need for extra investment in OoB Infrastructure for ports that would remain unused, which reduces the initial cost of OoB deployment. When new OoB technologies become available and start to be deployed, there is no need for overhauling the existing OoB Infrastructure based on this system. New Connectors that interface with the new technology would be connected to the Managed Device, and the device would be able to attach to the existing OoB infrastructure. During the transition period between the disconnection of legacy OoB interfaces and its subsequent replacement by new OoB interfaces, Users would be able to gradually remove the legacy Managed Devices along with their Connectors, and install new Managed Devices with their correspondent new Connectors. However, all the rest of the OoB infrastructure, including the Main Units and all the cabling already installed, would remain the same, considerably decreasing the transition overhead. Once the legacy OoB technology is replaced, only the investment made on Connectors is possibly lost. However, all the investment made in the OoB Infrastructure itself, i.e. Main Units, cabling and so on, is protected, as this infrastructure remains in use after the technology upgrade.

### BRIEF DESCRIPTION OF THE DRAWINGS

FIG. 1 illustrates a typical use of in-band tools;

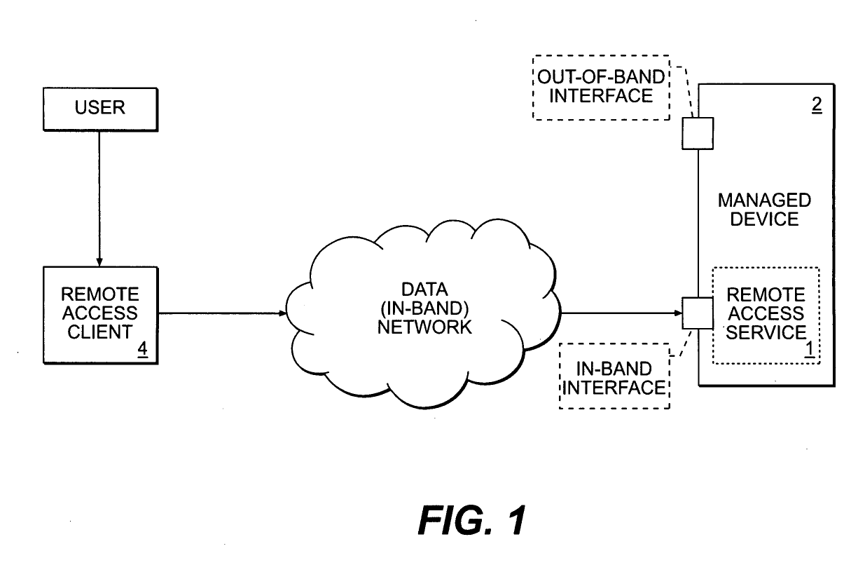

FIG. 2 illustrates a typical use of Out-of-Band tools;

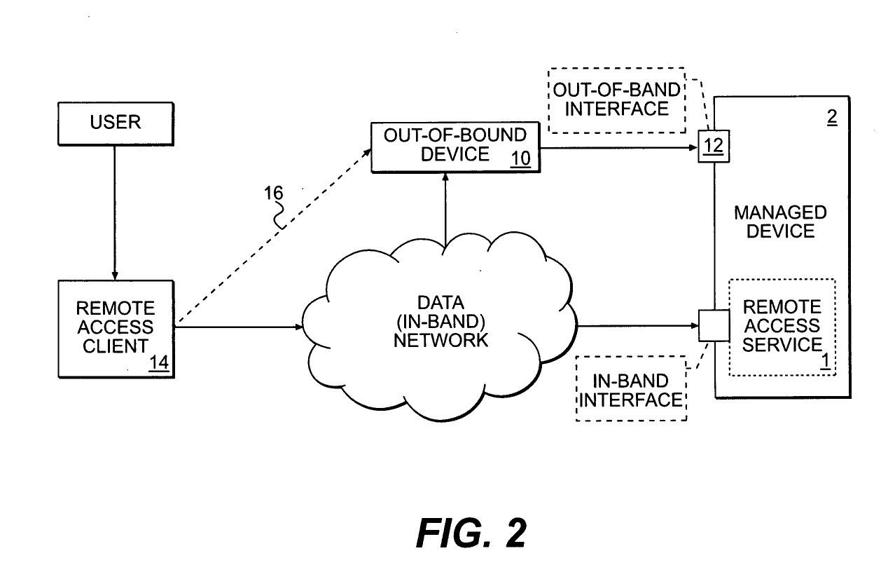

FIG. 3 illustrates a typical IT environment with in-band and Out-of-Band Tools using currently available Out-of-Band Devices;

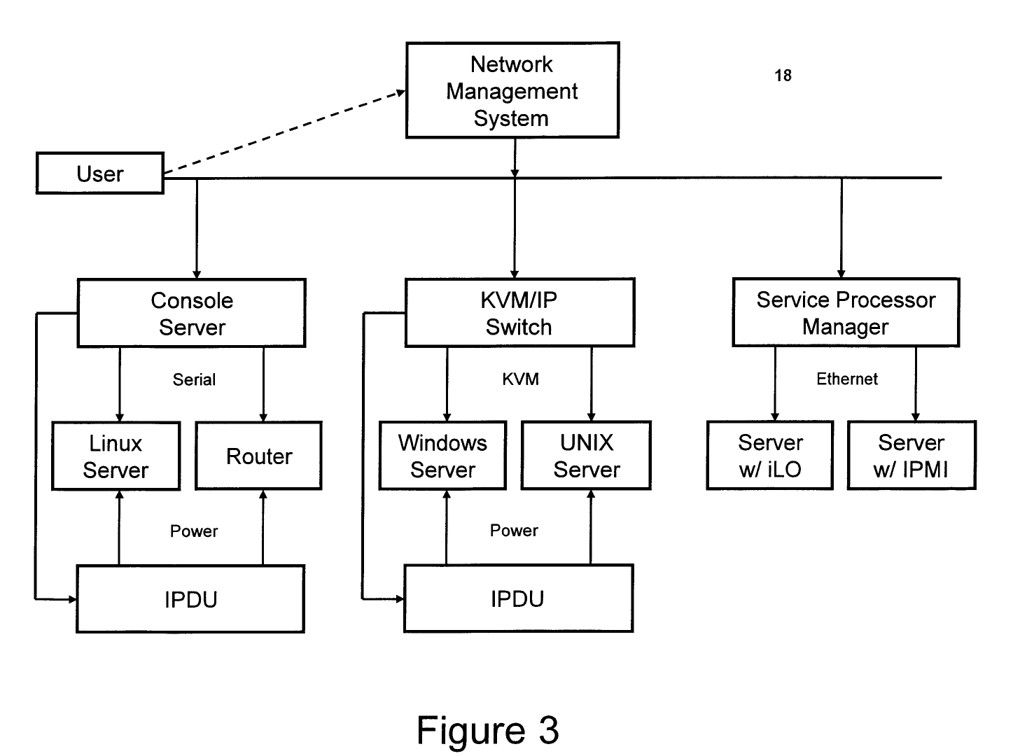

FIG. 4 is a block diagram illustrating an example of a preferred embodiment of the architecture of a Universal Out-of-Band Gateway in accordance with the invention;

FIG. 5 illustrates an IT system with OoB Tools that incorporates the Universal Out-of-Band Gateway in accordance with the invention as its OoB Device;

FIG. 6 details the OoB Infrastructure using the Universal Out-of-Band Gateway shown in FIG. 5;

FIG. 7 is a block diagram illustrating an example of a preferred embodiment of the implementation of the Universal Out-of-Band Gateway Hard Connector shown in FIG. 6;

FIG. 8 is a block diagram illustrating an example of a preferred embodiment of the implementation of the Universal Out-of-Band Gateway Main Unit shown in FIG. 6; and

FIG. 9 is a block diagram illustrating an example of a preferred embodiment of the software architecture of a preferred embodiment of the universal Out-of-Band gateway main unit shown in FIG. 6.

### DETAILED DESCRIPTION OF A PREFERRED EMBODIMENT

The invention is particularly applicable to an OoB Infrastructure that interfaces with multiple Managed Devices and OoB interfaces set forth below and it is in this context that the invention will be described. It will be appreciated, however, that the system and method in accordance with the invention has greater utility since 1) the system may be used with any existing interfaces and protocols as well as any newly developed interfaces and protocols; and 2) the system may be implemented in various manners that are within the scope of the invention.

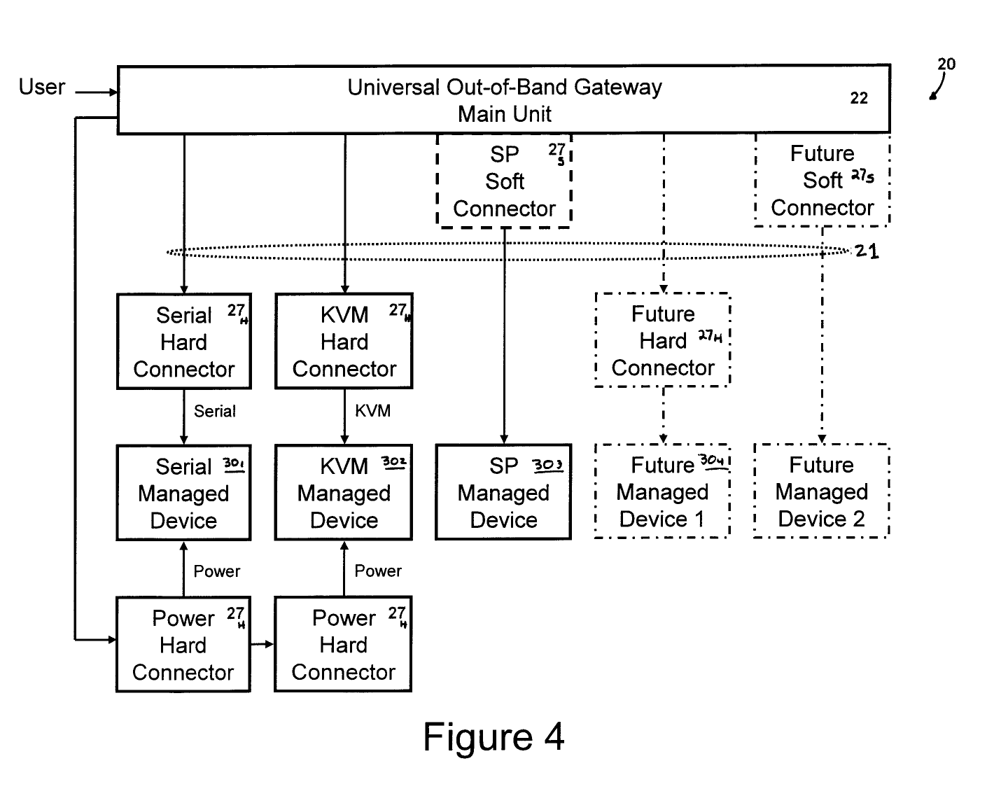

FIG. 4 illustrates a universal Out-of-Band gateway 20 in accordance with the invention. The gateway 20 comprises a main unit 22 that may be preferably implemented as a combination hardware and software. The gateway 20 may further comprise one or more connectors 27, such as a hard connector 27_{H}, a soft connector 27_{S} or a power connector shown or an environmental connector (not shown), that permits the main unit 22 to connect to one or more managed devices 30, such as a serial managed device 30₁, a KVM managed device 30₂, a service processor (SP) managed device 30₃ and a future managed device 30₄. As shown, additional software or hardware connectors may be later added to the gateway 20 to accommodate future managed devices 30₄ so that the gateway 20 in accordance with the invention can manage any currently existing managed devices as well as any later developed managed devices. As shown, the gateway is able to support the various existing Out-of-Band interfaces, such as serial, KVM, power or service processors, as well any later developed Out-of-Band interfaces. In accordance with the invention, the main unit 22 may be connected to/coupled to one or more connectors 27 by a common standard physical media 21 (which may be known as common media) wherein the common standard physical media may preferably be an Ethernet network or a universal serial bus (USB.)

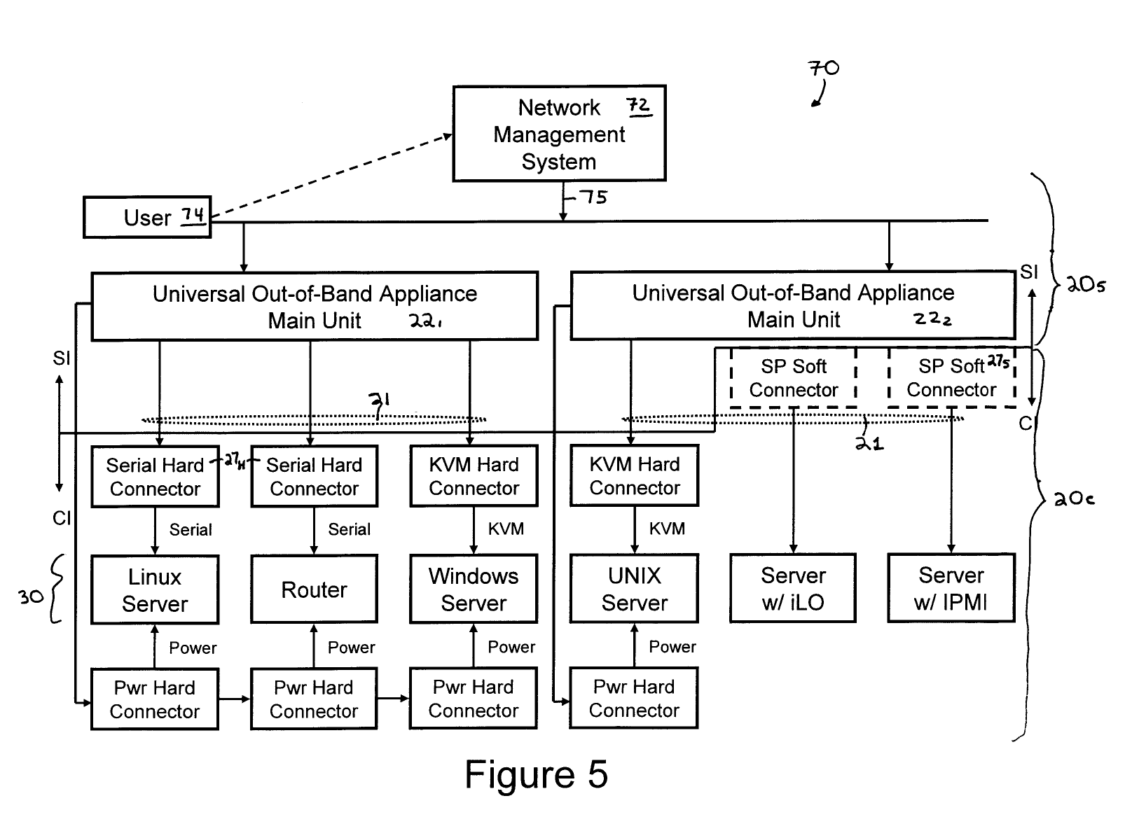

FIG. 5 depicts an IT system 70 that uses the universal out-of-band gateway 20 in accordance with the invention. It is important to note that the Universal Out-of-Band Gateway architecture allows for a clear separation between a stable infrastructure (SI) 20_{S} and a changing/changeable Infrastructure (CI) 20_{C} wherein the SI may include the main unit 22 and the common standard physical media 21 (shown here as the cabling already laid out to connect the main units to the Connectors) and the CI may include the connectors 27. This means that the investment in both capital expenses and operation expenses in the SI are protected in the long run. In accordance with the invention, the CI changes according to the life of the Managed Devices and the User requirements. Since the CI doesn't include the entire OoB Infrastructure, changes to the CI (such as a new connector) have less impact in the infrastructure management costs than in the original OoB Infrastructure architecture.

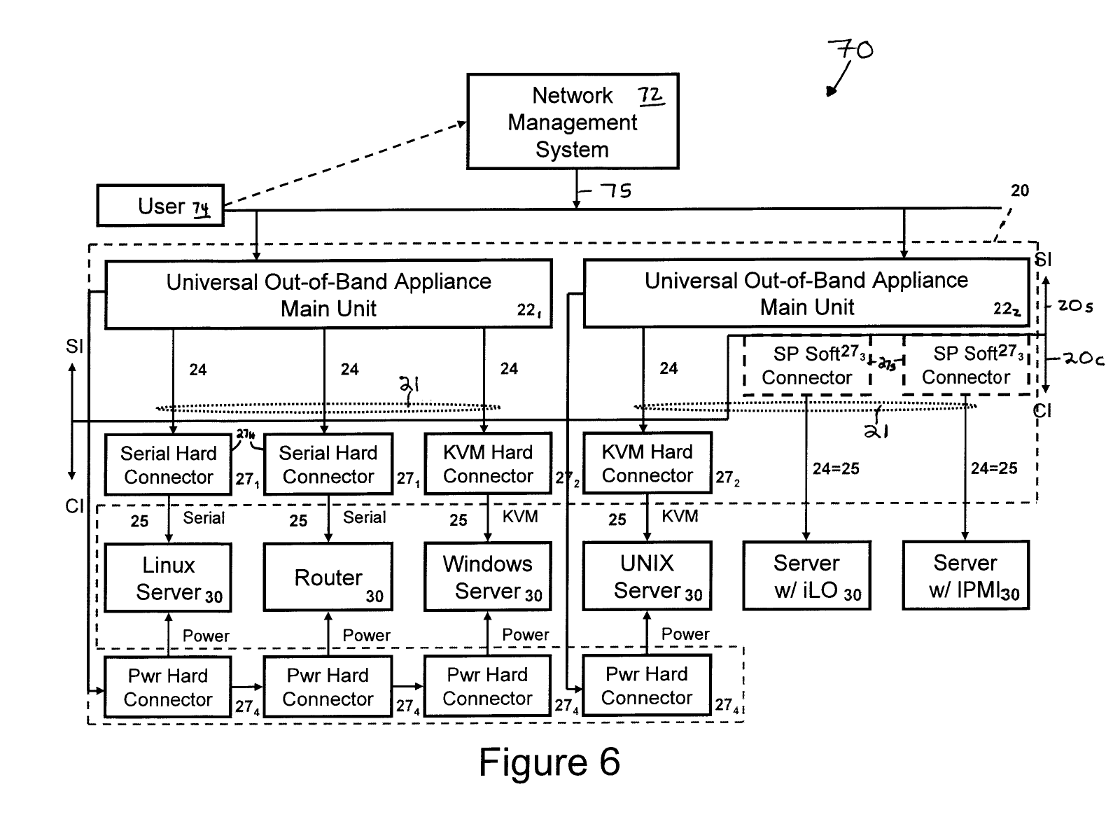

FIG. 6, which is a detailed version of FIG. 5, illustrates the IT system 70 using the Universal Out-of-Band Gateway system 20 in accordance with the invention. The system 70 may also include a known network management system 72 and a user computer 74 that are coupled to each other and the main unit 22 over a management network 75. The management network 75 may use a higher-end, secure protocol suitable for transport over a wide area network which may include but is not limited to the following protocols: Secure Shell (SSH), Secure Socket Layer (SSL), Extended Markup Language (XML), Secure HyperText Transfer Protocol (HTTPS), or Data Center Markup Language (DCML). The network management system 72 may perform typical network management functions such as consolidating the management data from various management data sources and control the operation of the managed devices through the management protocols. The user computer 74 may permit a user, such as a network manager, to remotely log into the network management system.

The system 20 may include one or more Universal Out-of-Band Gateway Main Units 22, such as main unit 22₁ and main unit 22₂, wherein each main unit can handle a predetermined number of connectors so that the system 20 can be expanded to handle additional connectors (and thus additional managed devices) by adding more main units 22. Each of the main units 22 is typically composed by hardware and software components that perform some functions/operations. Each main unit 22 monitors a particular set type of Managed Devices. Each managed device may be accessed by different types of physical media 25, such as the RS-232 used to monitor and manage Linux and UNIX servers and network equipment using the well known RS-232 protocol. Another example of the physical media is the KVM interface that is used to monitor Windows servers with a well known KVM protocol. In this system, each main unit 22 monitors and manages a particular managed device or group of managed devices 30, including but not limited to UNIX and Linux Servers, Windows Servers, Blade Servers and Blade chassis, Telecommunication equipment, network routers, switches, load balancers, network attached storage and remote access servers.

As shown, each Managed Device may utilize a different OoB interface and/or protocol, such as RS-232, KVM, power, or Ethernet interfaces, and/or IPMI, HP iLO, Dell DRAC, Sun ALOM, IBM RSA and other protocols. In accordance with the invention, despite the different out-of-band protocols and interfaces, the managed devices 30 all may be connected to the same main unit 22 by using the different types of hard connectors 27_{H} and soft connectors 27_{S} for each different managed device using each different out-of-band protocols and interfaces. The connectors 27 all interface with the main unit 22 through an interface 24 to the common standard physical media 21 and with the managed device 30 through an OoB interface 25, such as the serial interface or KVM interface. In some cases, such as with service processors, the OoB interface 25 is the same as the network interface 24 so that the soft connector 27_{S} may be used as there is no need for physical media conversion since only a protocol conversion is required. In the example shown in FIG. 6, the connectors may include Serial Hard Connectors 27₁ that are used to connect to Linux servers and Routers, KVM Hard Connectors 27₂ that are used to connect to Windows and UNIX servers, and Service Processor Soft Connectors 27₃ that are used to connect to iLO and IPMI servers. The hard connectors 27_{H} are used since the particular out-of-band interface/protocol requires some hardware conversion of the interface, such as a serial out-of-band management data interface has to be converted into Ethernet to be communicated over the common media. Also, whenever required, one or more Power Hard Connectors 27₄ may be used to provide power control to the managed devices 30. The connectors 27 may also include an environmental connector (not shown) that connect to a managed device that measures the temperature, humidity or a water leak at a managed site.

In accordance with the invention, the Universal Out-of-Band Gateway Main Unit 22 further comprises a set of gateway software modules each comprising a plurality of lines of computer code that implement the functions of the gateway software described below. The gateway software modules may be executed by a processor that is part of the main unit 22 and the software modules may be stored in a storage device associated with the main unit. As shown in FIG. 6, the Universal Out-of-Band Gateway Main Unit 22 consolidates the management data from the various Managed Devices 30 with the various different OoB interfaces and converts the management data into a common format as described below in more detail so that the management data of the Managed Devices can be transported over the network 75 to a local or remote management workstation or network management system over a single network session. The gateway software may also encrypt the management data using well known techniques and then communicate the data over the communications network using well known protocols. Thus, the Universal Out-of-Band Gateway is able to enforce a security protocol for all of the management data. In a preferred embodiment, the encrypted or unencrypted management data from the Universal Out-of-Band Gateway is communicated to the network management system and/or workstation using the well known simple network management protocol (SNMP), a web-based protocol (HTTPS), SSH protocol, Secure Socket Layer (SSL) protocol, Extended Markup Language (XML) protocol, and/or Data Center Markup Language (DCML) protocol. In accordance with the invention, the protocol used to communicate the management data from the Universal Out-of-Band Gateway to the network management system may be changed/updated to any protocol without departing from the scope of the invention.

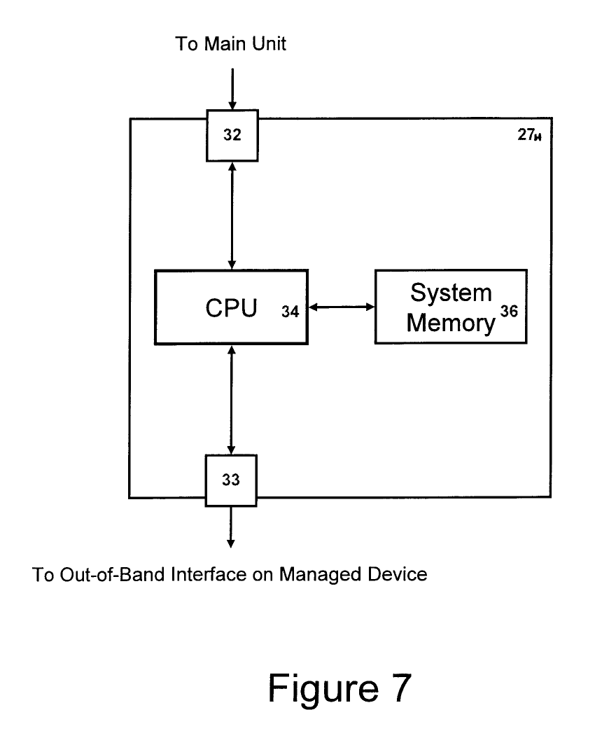

FIG. 7 is a diagram illustrating an example of a preferred embodiment of the implementation of the Universal Out-of-Band Gateway Hard Connector 27_{H}. The hard connector 27_{H} further comprises a physical interface 32, such as an Ethernet or USB interface, for connection to the Main Unit so that the Hard Connector can establish a point-to-point connection with the main unit. The hard connector 27_{H} further comprises an OoB physical interface 33 which varies depending on the type of Hard Connector. For example, a Serial Hard Connector has an RS-232 as its OoB interface, a KVM Hard Connector has keyboard, video and mouse interface as its OoB interface. The hard connector 27_{H} further comprises a processor 34, such as a CPU, that executes the Hard Connector software that may be stored in a system memory 36. The hard connector software allows the Hard Connector 27 to convert the physical media and the OoB protocols from the Managed Device to the Main Unit and vice-versa, as well as perform other functions related to OoB management. In accordance to this invention, other hardware and software capabilities such as support for different OoB interfaces and virtual media emulation capability may be added without departing from the scope of the invention.

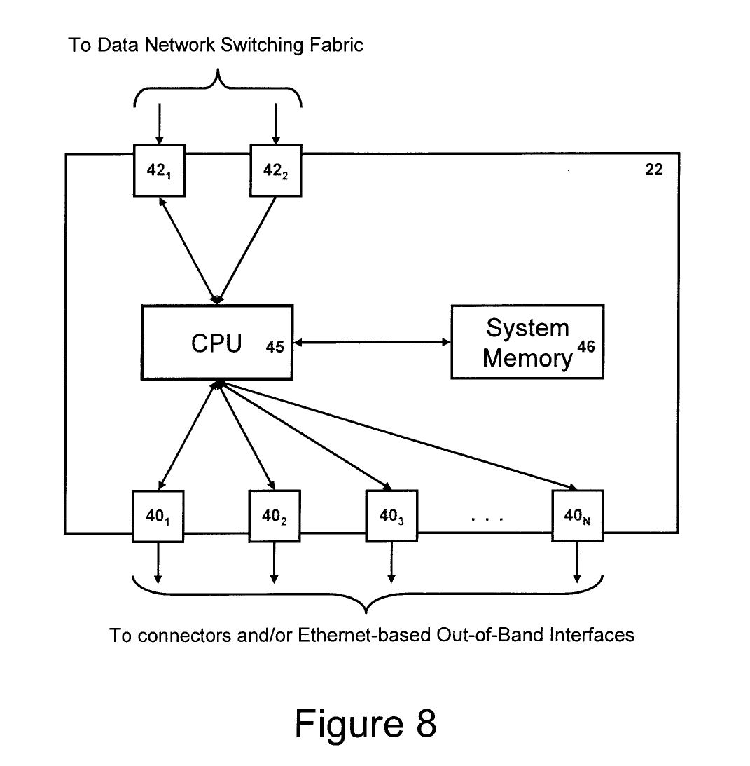

FIG. 8 is a diagram illustrating an example of a preferred embodiment of the implementation of the Universal Out-of-Band Gateway Main Unit 22. The main unit may comprise a plurality of local network physical interfaces 40₁-40_{N}, used to connect the Hard Connectors and/or the network-based OoB interfaces (for the Managed Devices that use Soft Connectors) to the Main Unit 22. In a preferred embodiment, the network interfaces may be Ethernet or USB interfaces. The local network interfaces 40₁-40_{N} provide point-to-point connections between the main unit and the respective connector and are not interconnected in a switching fabric as in a traditional Ethernet switch. The main unit may further comprise a processor 45, such as CPU, that terminates all the local network connections 40₁-40_{N} and executes the Universal Out-of-Band Gateway Main Unit software stored in a system memory 46, which includes but is not limited to the Soft Connector software modules. The main unit may further comprise one or more separate external network interfaces, such as the interfaces 42₁-42₂ shown in FIG. 8, that are used to connect to a data network 75 switching fabric. The multiple external network interfaces could be used amongst other reasons to provide connectivity from multiple network segments to the Main Unit 22, or redundant connectivity to the same network segment. The local network interfaces 40₁-40_{N} are not directly visible to the network as in a traditional switch or router since the Universal Out-of-Band Gateway Main Unit 22 physically isolates the OoB interface connections from the data network. In accordance with the invention, other hardware capabilities such as different network interfaces, disk storage capability, and hardware expansion through standard interfaces such as PCI, PCMCIA, IDE, PCI-X, and USB may be added without departing from the scope of the invention.

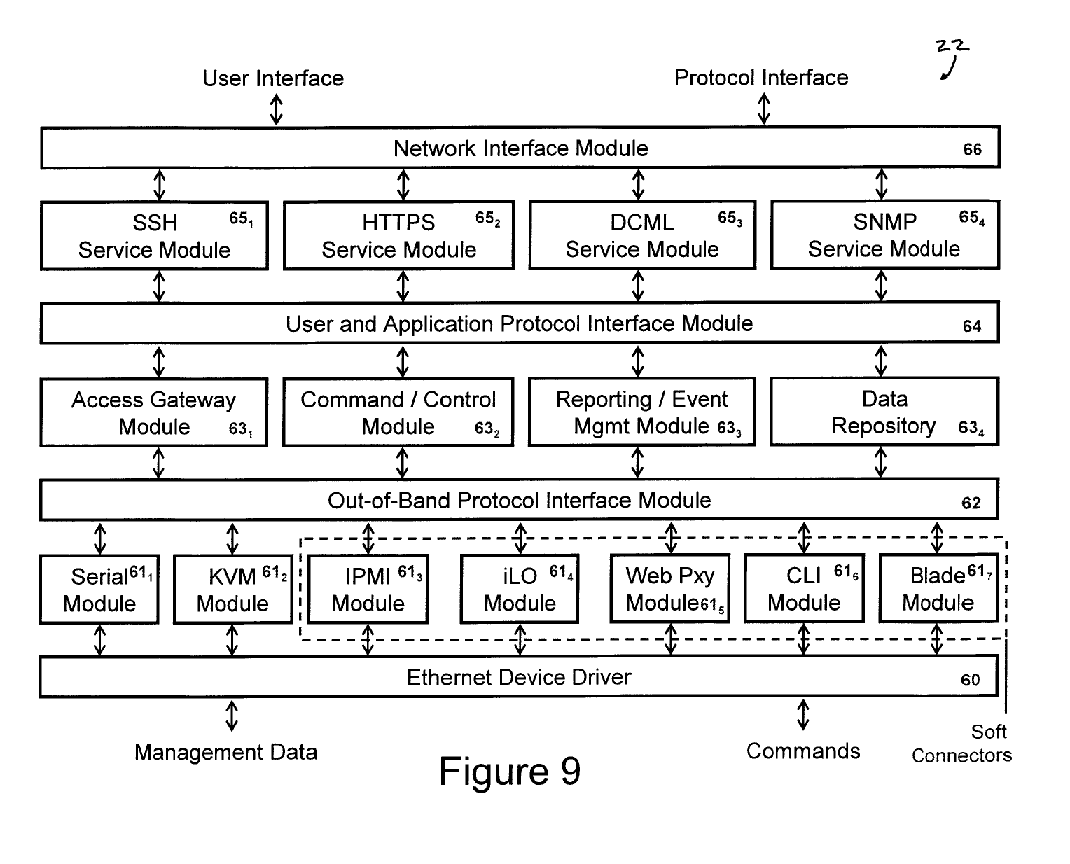

FIG. 9 is a diagram illustrating an example of a preferred embodiment of the software architecture of the Universal Out-of-Band Gateway Main Unit 22. The software modules of the main unit 22 may include a network device driver 60, such as an Ethernet device driver in the preferred embodiment, that exchanges the management data, commands with the connectors. The main unit software may further comprise a set of connectivity modules 61 specific to each particular type of OoB interface. The connectivity modules 61 may interface with hard connectors, which is the case with Serial and KVM Hard Connectors, or may interface directly with Ethernet-based OoB interfaces and their protocols, which is the case with service processor-equipped devices. In the latter case, the connectivity module is the soft connector described above.

For the serial interfaces, a serial connectivity module 61₁ communicates with the Serial Hard Connector, which in turn communicates with the serial interface in the Managed Device. For KVM interfaces, the KVM connectivity module 61₂ communicates with the KVM Hard Connector, which in turn communicates with the KVM interface in the Managed Device. For service processors, the IPMI connectivity module 61₃ communicates with IPMI service processors; the iLO connectivity module 61₄, with iLO service processors, and so on. Each connectivity module 61 is able to receive the management data from the respective type of out-of-band protocol and exchange commands with the connector using the proper management protocol. A Web Proxy connectivity module 61₅ communicates with service processors and management modules using a web-based interface. A CLI connectivity Module 61₆ communicates with generic management agents offering a command line interface and a Blade connectivity Server module 61₇ communicates with management modules in blade computers and telecommunication chassis. As OoB interfaces evolve and new proprietary and standard protocols are created, new Connectivity Modules (along with Hard Connectors, if applicable) can be added to the architecture without departing from the scope of this invention.

The connectivity modules 61 terminate the session with the OoB interfaces so that the management traffic is isolated from the data network and the OoB protocols are not propagated to the data network. Thus, network addresses used in the local network connections have only local scope and are not exposed to the data network so that there is no requirement for network address (IP address in a TCP/IP network) to be provisioned in the data network or be specifically secured by the managers of the data network.

The main unit software may further comprise a common OoB Protocol Interface Module 62 that provides a uniform interface between the Connectivity Modules 61 and one or more Application Modules 63. The Application Modules 63 offer different types of functionality so that the data collected from the OoB interfaces can be presented in a consolidated and meaningful way to local or remote Users and management systems. Thus, the application modules 63 may include a Access Gateway Module 63₁ that acts as a protocol gateway and provides direct access to the OoB interface's user interface. A Command/Control Module 63₂ offers a uniform and platform-independent set of commands to the User and translates the uniform commands into commands that are specific to the type of OoB interface as described in more detail below. A Reporting/Event Management Module 63₃ collects data in a data repository 63₄ and provides reports, notification of exceptions, and visualization of consolidated data to Users. As OoB interfaces and management techniques evolve, other applications modules can be added to the architecture without departing from the scope of this invention.

The software of the main unit may further comprise a User and Application Protocol Interface Module 64 that provides a uniform interface between the Application Modules 63 and a set of service modules 65. The Service Modules 65 provides services to remote human Users at management stations and/or Management Systems such as HP Open View, IBM Tivoli, BMC Patrol, and CA Unicenter using standard protocols suitable for transport over the data network. Through the Service Modules, remote Users and Management Systems can get access to the services provided by the Application Modules 63. For example, an SSH Service Module 65₁ provides Secure Shell Services to Users accessing the Universal Out-of-Band Gateway using a SSH client while an HTTPS Service Module 65₂ provides web access to Users accessing the Universal Out-of-Band Gateway using a web browser. A DCML Service Module 65₃ provides Universal Out-of-Band Gateway access to management systems using the Data Center Markup Language (DCML) and an SNMP Service Module 65₄ provides Universal Out-of-Band Gateway access to management systems using the Simple Network Management Protocol (SNMP). As network management techniques evolve new Service Modules can be added to the architecture without departing from the scope of this invention.

The software modules of the main unit may further comprise a Network Interface Module 66 that connects the Universal Out-of-Band Gateway to the data network using standard networking protocols such as TCP/IP. The network interface module may permit the main unit to exchange user interface data and acts as a protocol interface to the data network.

While the foregoing has been with reference to a particular embodiment of the invention, it will be appreciated by those skilled in the art that changes in this embodiment may be made without departing from the principles and spirit of the invention, the scope of which is defined by the appended claims.

1. A universal out-of-band gateway system, comprising:
one or more connectors that connect one or more managed devices to a main gateway unit over a common media and communicates out-of-band management data of the one or more managed devices to the main gateway unit, the one or more connectors being a changeable infrastructure that interfaces with two or more different out-of-band interfaces; and
the main gateway unit receives the management data and converts the out-of-band management data of the managed devices into a common management data format and wherein the main gateway unit is a stable infrastructure so that the stable infrastructure is separated from the changeable infrastructure.

2. The system of claim 1, wherein the one or more connectors further comprises a soft connector that comprises a piece of software that interfaces with the managed device.

3. The system of claim 2, wherein the soft connector further comprises a service processor connector that is capable of connecting a service processor to the gateway unit.

4. The system of claim 3, wherein the service processor connector further comprises one of an iLO connector and an IPMI connector.

5. The system of claim 2, wherein the soft connector further comprises a software module resident on the main gateway unit that is executed by a processor of the main gateway unit.

6. The system of claim 2, wherein the one or more connectors further comprises a hard connector that comprises a piece of hardware and software embedded in the piece of hardware that interface with the managed device.

7. The system of claim 1, wherein the one or more connectors further comprises a hard connector that comprises a piece of hardware and software embedded in the piece of hardware that interface with the managed device.

8. The system of claim 7, wherein the hard connector further comprises a processor, a memory and one or more software modules that are stored in the memory and executed by the processor to implement the management protocol conversion of the particular managed device.

9. The system of claim 8, wherein the hard connector further comprises a physical interface for connection to the main gateway unit wherein the physical interface establishes a point-to-point connection with the main gateway unit.

10. The system of claim 8, wherein the hard connector further comprises a serial connector and wherein the managed device further comprises one of a Linux server and a router.

11. The system of claim 8, wherein the hard connector further comprises a KVM connector and wherein the managed device further comprises one of a Linux server and a Windows-based server.

12. The system of claim 8, wherein the hard connector further comprises a power connector and wherein the managed device further comprises a power element for a managed device so that the power connector monitors the power of the managed device.

13. The system of claim 1, wherein the one or more connectors further comprises an environmental connector.

14. The system of claim 13, wherein the environmental connector connects to one of a temperature sensor, a humidity sensor and a water leak sensor.

15. The system of claim 14, wherein the one or more connectors further comprises a soft connector that comprises a piece of software that interfaces with a managed device.

16. The system of claim 15, wherein the one or more connectors further comprises a hard connector that comprises a piece of hardware that interfaces with a managed device.

17. The system of claim 1, wherein the common media further comprises one of an Ethernet network and a universal serial bus.

18. The system of claim 1, wherein the main gateway unit further comprises a processor, memory and one or more software modules that are stored in the memory and executed by the processor, the one or more software modules further comprising an out-of-band protocol interface module that converts each out-of-band protocol into a common management data format, one or more application modules that process the common management data to generate processed management data and one or more network interface modules that convert the processed management data into a particular network protocol.

19. The system of claim 1 further comprises a network management system connected to the main gateway unit by a secure management network protocol.

20. The system of claim 19, wherein the management network protocol further comprises one of secure shell, secure socket layer, extended markup language, secure hypertext transfer protocol and data center markup language.

21. The system of claim 1 further comprising one or more managed devices connected to the main gateway unit through the one or more connectors.

22. The system of claim 21, wherein the one or more managed devices further comprise one or more of a Unix server, a Linux server, a Windows server, a Blade server, a piece of telecommunications equipment, a network router, a switch, a load balancer, a network attached storage device and a remote access server.

23. The system of claim 1, wherein the out-of-band interfaces further comprise one or more of a RS-232 interface, a KVM interface, a power interface, an environmental interface, an Ethernet interface, a IPMI interface, an iLO interface, a DRAC interface, an ALOM interface and an RSA interface.

24. The system of claim 1, wherein the main gateway unit further comprises one or more network interfaces that provide a point-to-point connector from the connector to the main gateway unit.

25. A universal out-of-band management method, comprising:
receiving out-of-band management data from one or more managed devices over a common media to a changeable infrastructure portion; and
converting the out-of-band management data of the managed devices into a common management data format at a stable infrastructure portion, wherein the changeable infrastructure portion and the stable infrastructure portion are separated from each other.

26. The method of claim 25 further comprising adding a new managed device into the out-of-band management system wherein adding the new managed device further comprises adding a connector to the changeable infrastructure portion so that the stable infrastructure portion does not need modification for a new managed device.
